(19) United States
(12) Patent Application Publication
(10) Pub. No.: US 2025/0300493 A1
(43) Pub. Date: Sep. 25, 2025

(54) ELECTRONIC DEVICE AND POWER TRANSMISSION SYSTEM

(71) Applicant: CASIO COMPUTER CO., LTD., Tokyo (JP)

(72) Inventors: Masanobu SATOU, Tokyo (JP); Tomio HIGO, Tokyo (JP)

(73) Assignee: CASIO COMPUTER CO., LTD., Tokyo (JP)

(21) Appl. No.: 19/088,118

(22) Filed: Mar. 24, 2025

(30) Foreign Application Priority Data
Mar. 25, 2024 (JP) 2024-047440

(51) Int. Cl. H02J 50/10

(52) U.S. Cl. CPC H02J 50/10

(57) ABSTRACT

A power reception circuit supplies, to a battery, power wirelessly supplied from a power supply device through a power reception coil. A sensor detects a predetermined feature given to a predetermined part of the power supply device. The power reception circuit operates to allow power to be supplied from the power supply device to the battery in response to the sensor detecting the predetermined feature from the predetermined part of the sensor.

### CROSS-REFERENCE TO RELATED APPLICATIONS

This application claims the priority of Japanese Patent Application No. 2024-047440, filed on Mar. 25, 2024, the entire disclosure of which is incorporated by reference herein.

### FIELD OF THE INVENTION

The present disclosure relates to an electronic device and a power transmission system.

### BACKGROUND OF THE INVENTION

In recent years, electronic devices that receive wireless power supply from power supply devices and charge built-in batteries have been used. For example, Unexamined Japanese Patent Application Publication No. 2010-119251 discloses a technique in which a power transmission unit determines whether a power reception unit is a proper power reception unit.

### SUMMARY OF THE INVENTION

An electronic device according to the present disclosure includes a battery, a power reception coil, a power reception circuit that supplies power wirelessly supplied from a power supply device via the power reception coil to the battery, and a sensor that detects a predetermined feature given to a predetermined part of the power supply device. The power reception circuit operates to allow power to be supplied from the power supply device to the battery in response to the sensor detecting the predetermined feature from the predetermined part.

### BRIEF DESCRIPTION OF DRAWINGS

A more complete understanding of this application can be obtained when the following detailed description is considered in conjunction with the following drawings, in which:

FIG. 1 is a perspective view of an electronic device and a power supply device according to Embodiment 1;

FIG. 2 is a perspective view of a body of the electronic device according to Embodiment 1;

FIG. 3 is a configuration diagram of a power transmission system according to Embodiment 1;

FIG. 4 is a drawing illustrating an internal structure of a protrusion according to Embodiment 1;

FIG. 5 is a top view of the electronic device and the power supply device according to Embodiment 1 in a stored state;

FIG. 6 is a cross-sectional view taken along the A-A line illustrated in FIG. 5;

FIG. 7 is an enlarged view of an area enclosed by a dashed line 50 illustrated in FIG. 6;

FIG. 8 is an arrangement diagram of a magnet and a magnetic sensor according to Embodiment 1;

FIG. 9 is a graph illustrating electromagnetic conversion characteristics of the magnetic sensor according to Embodiment 1; and

FIG. 10 is a configuration diagram of a power transmission system according to Embodiment 2.

### DETAILED DESCRIPTION OF THE INVENTION

Embodiments of the present disclosure are described below in detail with reference to drawings. The same reference signs are used to refer to the same or corresponding components throughout the drawings.

### Embodiment 1

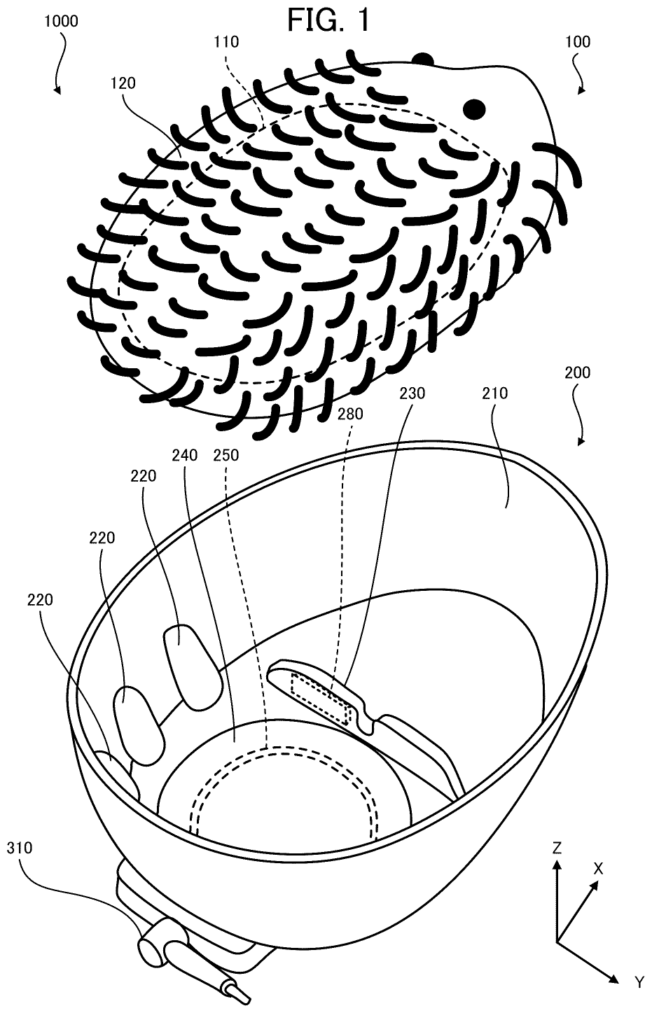

First, the appearance of an electronic device 100 and a power supply device 200 included in a power transmission system 1000 according to Embodiment 1 is described with reference to FIG. 1. The power transmission system 1000 is a system in which the power supply device 200 wirelessly supplies power to the electronic device 100. The power supply device 200 wirelessly supplies power to the electronic device 100 when the electronic device 100 is stored in a storage 210 of the power supply device 200. Wireless means that there are no cable connections, electrode contacts, or the like.

The electronic device 100 is a device that operates on the power stored in a built-in battery in the electronic device 100. The electronic device 100 charges the built-in battery with the power supplied by the power supply device 200. In this embodiment, the electronic device 100 is a robot that operates autonomously without direct user operation. More specifically, the electronic device 100 is a pet robot that imitates a small animal. The electronic device 100 includes a body 110 and an exterior 120.

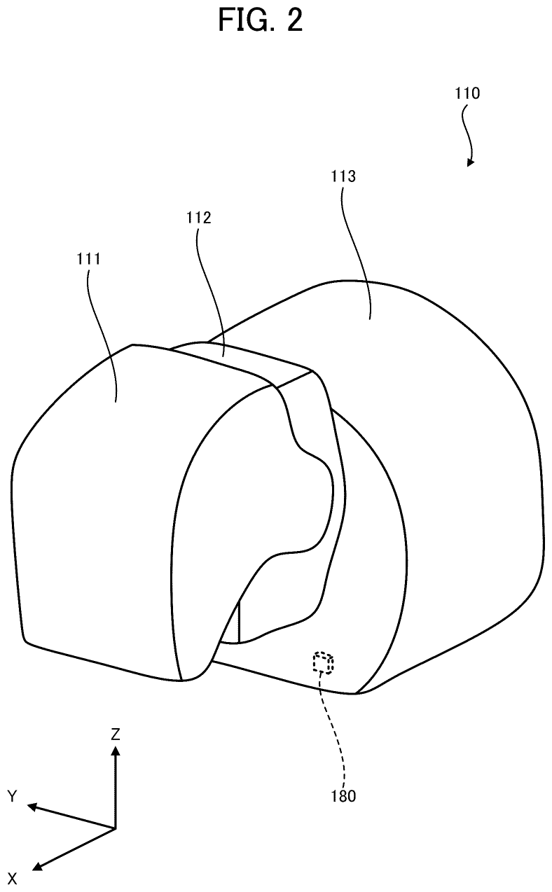

The body 110 contains various components necessary for operation of the electronic device 100. As illustrated in FIG. 2, the body 110 includes a head 111, a joint 112, and a torso 113. The head 111 corresponds to the head of a small animal. The joint 112 connects the head 111 to the torso 113 rotatably. The torso 113 corresponds to the body of a small animal. A magnetic sensor 180 is disposed inside the torso 113.

The exterior 120 covers the body 110. The exterior 120 includes eye-like decorative components, and fluffy fur. The surface material of the exterior 120 is, for example, made of an artificial pile fabric that imitates a small animal's fur, to simulate the feel of a small animal. The lining of the exterior 120 is made of, for example, fibers, leather, rubber, or the like. Since the exterior 120 is made of a flexible material, the exterior 120 can follow movement of the body 110.

The power supply device 200 is a device that supplies power wirelessly to the electronic device 100. The power supply device 200 functions as a charging station to charge the battery included in the electronic device 100. The power supply device 200 receives power from an alternating current (AC) adapter equipped with a direct current (DC) plug 310. The power supply device 200 includes the storage 210 for storing the electronic device 100. The storage 210 has a bowl-like shape that imitates a small animal's house. More specifically, the storage 210 has a shape that resembles an egg split in half along a plane that includes the central axis extending in the longitudinal direction.

A stand 240 for placing the electronic device 100 is provided at the bottom of the storage 210. The stand 240 has a disc shape. Below the stand 240, a power transmission coil 250 is provided. The power supply device 200 wirelessly supplies power to the electronic device 100 when the electronic device 100 is placed on the stand 240. An alternating current flows through the power transmission coil 250 for power supply. A plurality of protrusions 220 is disposed inside the side wall of the storage 210. The protrusions 220 are members to restrict movement of the electronic device 100 in the horizontal direction in a state in which the electronic device 100 is stored in the storage 210 (hereinafter referred to as a “stored state” as appropriate), making it possible to supply power to the electronic device 100. A protrusion 230 is provided in the center of the inner side of the bottom of the storage 210. The protrusion 230 is a member to restrict movement of the electronic device 100 in the longitudinal direction of the storage 210 in the stored state. The protrusion 230 has a shape extending in the width direction of the storage 210. The protrusions 220 and the protrusion 230 are preferably arranged to allow for some movement of the electronic device 100 so that the movement is not excessively restricted. In this configuration, for example, the breathing motion simulated by the electronic device 100 imitating a small animal within the storage 210 imitating a small animal's house is not restricted. The magnet 280 is provided inside the protrusion 230.

In this embodiment, the axis extending in the vertical direction is the Z-axis, the axis extending in the direction orthogonal to the Z-axis is the X-axis, and the axis extending in the direction orthogonal to both the Z-axis and the X-axis is the Y-axis. In this embodiment, the power supply device 200 is arranged such that the direction extending from the rear end to the front end of the storage 210 in the longitudinal direction is the positive direction of the X-axis. The front end in the longitudinal direction of the storage 210 is the more pointed end among both ends in the longitudinal direction of the storage 210. In addition, in this embodiment, the electronic device 100 is arranged such that the direction extending from the torso 113 to the head 111 is the positive direction of the X-axis. In other words, in this embodiment, the head 111 of the body 110 of the electronic device 100 is arranged at the front end in the longitudinal direction of the storage 210 of the power supply device 200, and the electronic device 100 is stored in the storage 210 of the power supply device 200.

The electronic device 100 may be stored in the storage 210 either automatically or manually. For example, the electronic device 100 may automatically move into the storage 210 in response to the remaining battery level falling below a reference value. Alternatively, the user may store the electronic device 100 in the storage 210 in accordance with notification from the electronic device 100. This notification indicates that the remaining battery level is low and is issued by the electronic device 100 in response to the remaining battery level falling below the reference value.

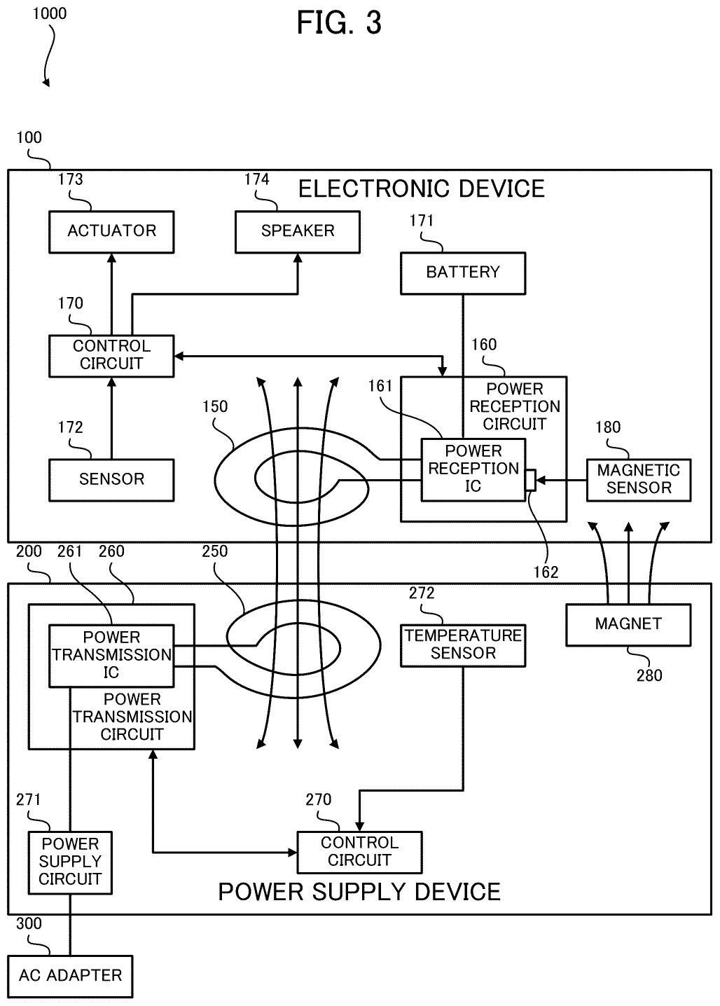

Next, the configuration of the power transmission system 1000 is described with reference to FIG. 3. The power transmission system 1000 includes the electronic device 100 and the power supply device 200. The electronic device 100 includes a power reception coil 150, a power reception circuit 160, a control circuit 170, a battery 171, a sensor 172, an actuator 173, a speaker 174, and a magnetic sensor 180. The power supply device 200 includes a power transmission coil 250, a power transmission circuit 260, a control circuit 270, a power supply circuit 271, a temperature sensor 272, and a magnet 280.

The power reception coil 150 is a coil that couples with the power transmission coil 250 and receives power wirelessly. The power reception coil 150 induces an electromotive force in accordance with changes in the magnetic flux induced by the power transmission coil 250. The power reception coil 150 is a wire wound around an axis extending in the Z-axis direction. The power reception coil 150 is located below the stand 240.

The power reception circuit 160 is a circuit that receives power wirelessly through the power reception coil 150. The power reception circuit 160 supplies, to the battery 171, direct current power based on the alternating current power supplied from the power supply device 200 through the power reception coil 150. The power reception circuit 160 operates in accordance with control by the control circuit 170. The power reception circuit 160 communicates with the power transmission circuit 260. For example, the power reception circuit 160 sends a power supply request to the power transmission circuit 260 to receive power from the power transmission circuit 260. The power reception circuit 160 includes a power reception integrated circuit (IC) 161.

The power reception IC 161 converts alternating current power generated by the electromotive force induced by the power reception coil 150 into direct current power, and supplies the direct current power to the battery 171. The power reception IC 161 includes an operation control terminal 162 for controlling the operation of the power reception IC 161. The power reception IC 161 operates when a first voltage is applied to the operation control terminal 162 and stops operating when a second voltage is applied to the operation control terminal 162. In this embodiment, the first voltage is lower than the second voltage. For example, the first voltage is 0.2 V and the second voltage is 1.6 V.

When the first voltage is applied to the operation control terminal 162, the power reception IC 161 operates. Therefore, the power reception circuit 160 sends a power supply request to the power transmission circuit 260, and the power supply device 200 performs power supply. When the second voltage is applied to the operation control terminal 162, the power reception IC 161 stops operating. Thus, the power reception circuit 160 does not send a power supply request to the power transmission circuit 260, and power supply by the power supply device 200 is not performed.

In this embodiment, the voltage output by the magnetic sensor 180 is applied to the operation control terminal 162. In other words, in this embodiment, availability of power supply by the power supply device 200 is determined based on a result of magnetism detection made by the magnetic sensor 180. Specifically, when the magnetic sensor 180 detects magnetism, power supply by the power supply device 200 is executed. When the magnetic sensor 180 does not detect magnetism, power supply by the power supply device 200 is not executed. In this case, the operation control terminal 162 is an/EN terminal.

The control circuit 170 controls the overall operation of the electronic device 100. For example, the control circuit 170 operates the electronic device 100 by operating the actuator 173 based on a result of detection made by the sensor 172. Also, when the control circuit 170 receives a notification from the power supply device 200 that a foreign object is detected, the control circuit 170 controls the speaker 174 to notify the user that a foreign object is detected.

The battery 171 is a secondary battery capable of charging and discharging. The battery 171 is a power source of the electronic device 100. In other words, the battery 171 supplies power to the power reception circuit 160, the control circuit 170, the sensor 172, the actuator 173, the magnetic sensor 180, etc. The battery 171 is charged by the power supplied from the power reception circuit 160.

The sensor 172 is a sensor for detecting various physical quantities. Examples of the sensor 172 include a touch sensor, an acceleration sensor, an angular velocity sensor, a sound sensor, an illuminance sensor, and a temperature sensor. The touch sensor, for example, detects that the user touches the exterior 120. The acceleration sensor, for example, detects acceleration applied to the entire or part of the electronic device 100. The angular velocity sensor, for example, detects an angular velocity of the entire or part of the electronic device 100. The sound sensor, for example, detects sound emitted by the user. The illuminance sensor, for example, detects illuminance around the electronic device 100. The temperature sensor, for example, detects internal or external temperature of the electronic device 100. The sensor 172 supplies to the control circuit 170 an electrical signal indicating a result of the detection.

The actuator 173 is a mechanism for operating each part of the electronic device 100. The actuator 173 operates in accordance with the control by the control circuit 170. For example, the actuator 173 is a mechanism for moving the electronic device 100 forward and backward and for rotating the head 111 relative to the torso 113. The actuator 173 includes, for example, a stepping motor.

The speaker 174 emits sound in accordance with the control by control circuit 270. For example, when the power supply device 200 detects a foreign object, the speaker 174 outputs a sound notification indicating that a foreign object is detected, in accordance with an audio signal supplied from control circuit 270.

The magnetic sensor 180 is a sensor that detects magnetism. The magnetic sensor 180 detects magnetism generated by the magnet 280 provided in a predetermined part of power supply device 200. In this embodiment, the magnetic sensor 180 includes a Hall element that detects a magnetic field using the Hall effect and detects the strength of the magnetic field and the orientation of the magnetic pole. However, in this embodiment, the magnetic sensor 180 outputs a voltage corresponding to the strength of the magnetic field regardless of the orientation of the magnetic pole. Specifically, the magnetic sensor 180 outputs a first voltage when the detected strength of the magnetic field is equal to or greater than a reference value. Additionally, magnetic sensor 180 outputs the second voltage when the detected strength of the magnetic field is less than the reference value. In this way, the magnetic sensor 180 outputs the first voltage when detecting magnetism and outputs the second voltage when not detecting magnetism. The detection of magnetism by the magnetic sensor 180 corresponds to the strength of the magnetic field detected by the magnetic sensor 180 being equal to or greater than the reference value. The voltage output by the magnetic sensor 180 is applied to the operation control terminal 162 of the power reception IC 161. Therefore, power supply is allowed when magnetism is detected and not allowed when magnetism is not detected. In this embodiment, the power transmission coil 250 included in the power supply device 200 generates magnetism. Thus, the magnetic sensor 180 is positioned and angled to avoid detecting the magnetism generated by the power transmission coil 250.

The power transmission coil 250 is a coil that couples with the power reception coil 150 and is used to supply power wirelessly. The power transmission coil 250 induces a magnetic flux with a varying magnitude when an alternating current flows through the power transmission coil 250. The power transmission coil 250 is a wire wound around an axis extending in the Z-axis direction. In the stored state, the power transmission coil 250 is disposed in a predetermined position within the power supply device 200 such that the power transmission coil 250 faces the power reception coil 150. In the stored state, the central axis of the power reception coil 150 and the central axis of the power transmission coil 250 are close to each other.

The power transmission circuit 260 is a circuit for wirelessly supplying power through the power transmission coil 250. The power transmission circuit 260 supplies, to the power transmission coil 250, alternating current power based on the direct current power supplied from the power supply circuit 271. The power transmission circuit 260 operates in accordance with the control by the control circuit 270. The power transmission circuit 260 communicates with the power reception circuit 160. Specifically, when the power transmission circuit 260 receives a power supply request from the power reception circuit 160, the power transmission circuit 260 starts supplying power to the power reception circuit 160. The power transmission circuit 260 includes a power transmission IC 261. The power transmission IC 261 converts the direct current power generated by the power supply circuit 271 into alternating current power and supplies the alternating current power to the power transmission coil 250.

The control circuit 270 controls the overall operation of the power supply device 200. For example, the control circuit 270 controls the power transmission circuit 260 to supply power to the electronic device 100. Also, the control circuit 270 detects a foreign object based on the result of the detection made by the temperature sensor 272. For example, the control circuit 270 determines that there is a foreign object around the power transmission coil 250 when the temperature detected by the temperature sensor 272 is equal to or greater than a reference value. When the control circuit 270 determines that there is a foreign object, the control circuit 270 notifies the electronic device 100 that a foreign object is detected, prompting the electronic device 100 to notify that there is a foreign object.

The power supply circuit 271 generates various types of power supply voltages used by the power supply device 200. For example, the power supply circuit 271 steps down or steps up the direct current voltage supplied from AC adapter 300 to generate the power supply voltages for the various components of the power supply device 200.

The temperature sensor 272 detects the temperature around the power transmission coil 250. When there is a foreign object including metal around the power transmission coil 250, the change in magnetic flux induced by the power transmission coil 250 causes eddy currents to flow within the foreign object, causing the foreign object to generate heat. The temperature sensor 272 is used to detect the heat generation of the foreign object. The temperature sensor 272 supplies a result of the detection of the temperature to control circuit 270. Temperature sensor 272 includes, for example, a thermistor.

The magnet 280 is an object that generates magnetism. The magnet 280 has two poles, an N pole and an S pole, and is an object that is a source of a bipolar magnetic field. The magnet 280 is arranged in a predetermined part in the power supply device 200 to indicate that the power supply device 200 is a suitable power supply device for supplying power to the electronic device 100. In this embodiment, the predetermined part is the protrusion 230. The magnet 280 is arranged at a position and an angle corresponding to the position and angle of the magnetic sensor 180. In other words, in the stored state, the magnet 280 is positioned and angled to enable detection by the magnetic sensor 180 of the magnetism generated by the magnet 280. In this embodiment, the magnet 280 is a permanent magnet.

The AC adapter 300 is a device for converting alternating current power into direct current power. In this embodiment, the AC adapter 300 converts the alternating current power supplied from the commercial power supply into direct current power, and supplies the direct current power to the power supply circuit 271. The AC adapter 300 includes a DC plug 310 to be connected to the power supply circuit 271.

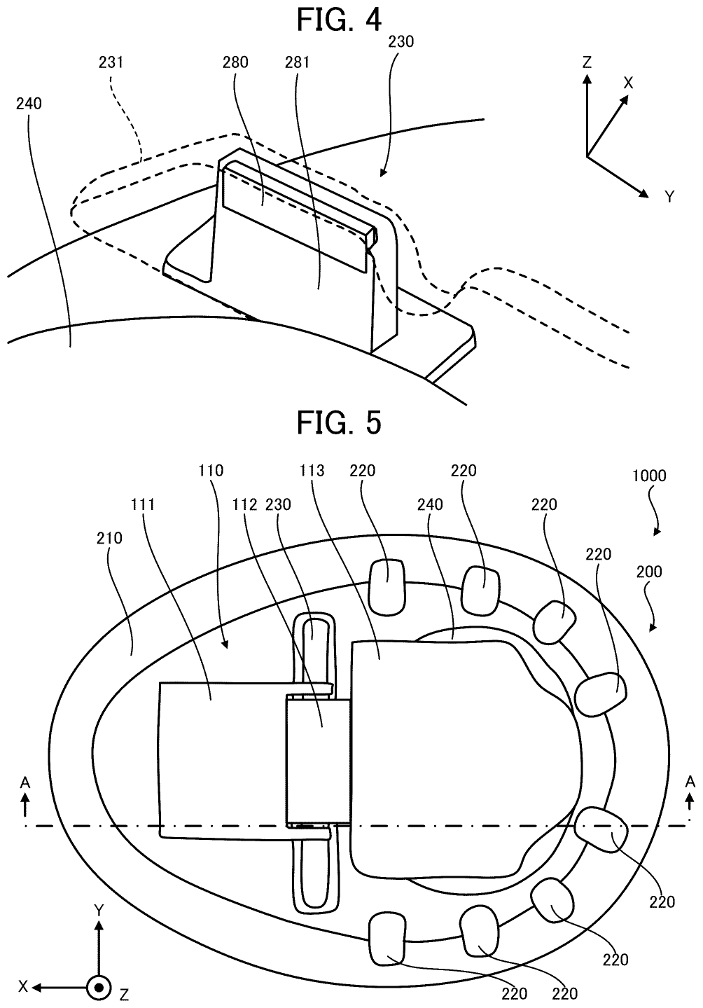

Next, the arrangement of the magnet 280 is described with reference to FIG. 4. As illustrated in FIG. 4, the magnet 280 is disposed inside the protrusion 230. In FIG. 4, for ease of understanding, a member 231 forming the outline of the projection 230 is shown as a dashed line, and the magnet 280 and the support member 281 stored inside the projection 230 are shown as solid lines. The surfaces of the magnet 280 and the support member 281 are covered by the member 231.

The magnet 280 has a substantially rectangular parallelepiped shape where the length in the longitudinal direction is longer than the length in the width direction, and the length in the width direction is longer than the length in the thickness direction. The support member 281 is a member that supports the magnet 280. The support member 281 has a function of fixing the position and angle of the magnet 280 in the stored state so that the magnetic sensor 180 can detect magnetism generated by the magnet 280. In this embodiment, the support member 281 fixes the magnet 280 such that the longitudinal direction of the magnet 280 is the Y-axis direction, the width direction of the magnet 280 is the Z-axis direction, and the thickness direction of the magnet 280 is the X-axis direction.

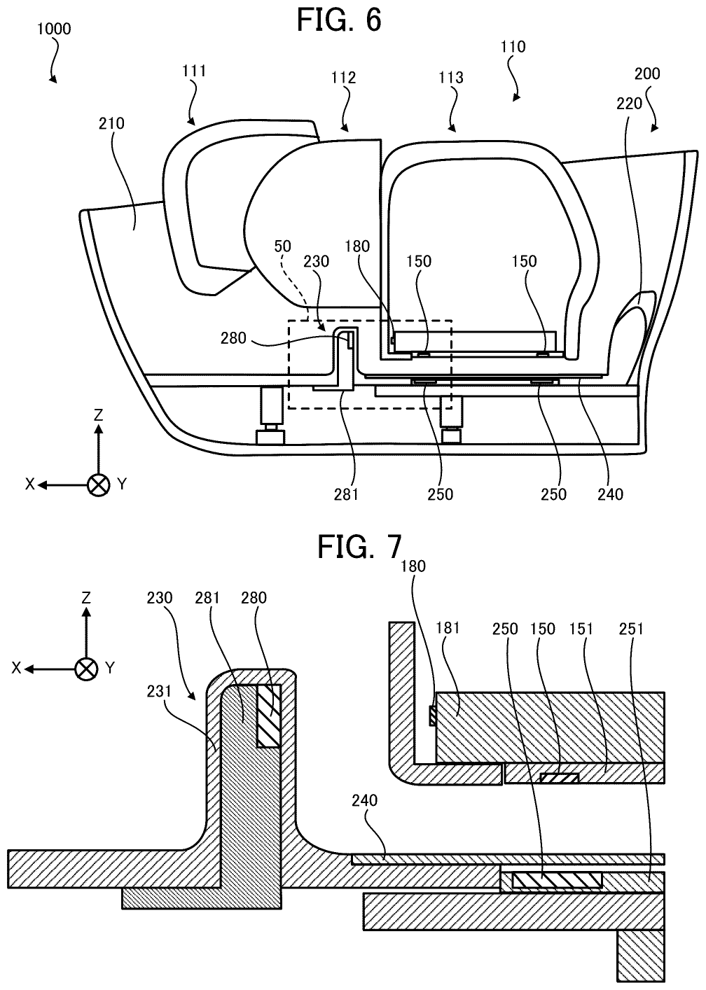

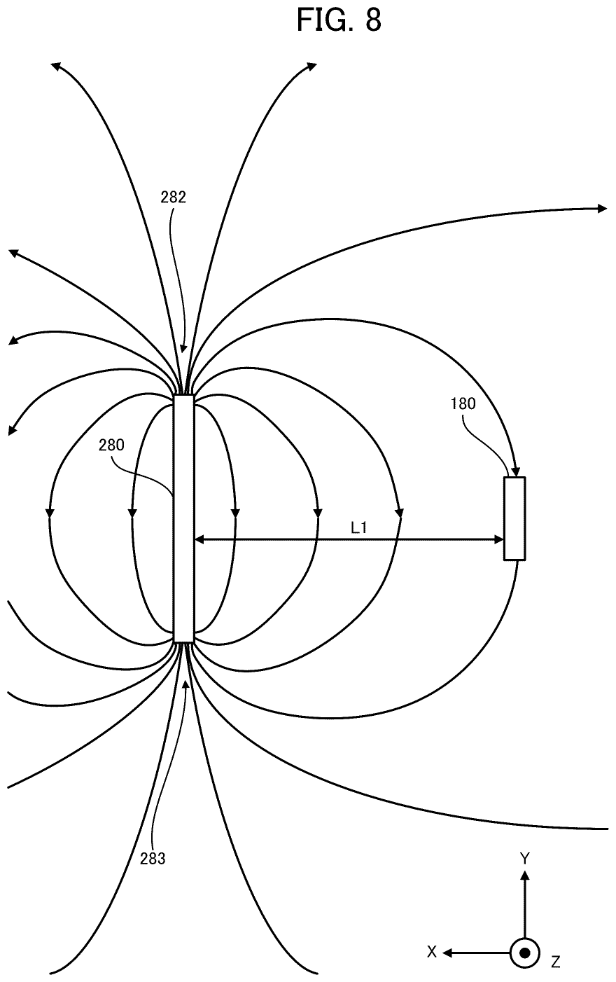

Next, the arrangement of the magnetic sensor 180 and the magnet 280 are described with reference to FIGS. 5, 6, and 7. In FIGS. 5, 6, and 7, for ease of understanding, the electronic device 100 is illustrated with the exterior 120 omitted, and only the body 110 is illustrated. Also, in FIG. 6, for ease of understanding, the hatching on the cross-sections is omitted. As illustrated in FIG. 5, in the stored state, the protrusions 220 and the protrusion 230 restrict the movement of the electronic device 100 in the X-axis and Y-axis directions. Specifically, the protrusions 220 restrict the movement of the torso 113 in the X-axis and Y-axis directions, and the protrusion 230 restricts the movement of the torso 113 in the X-axis direction. Moreover, as illustrated in FIGS. 6 and 7, in the stored state, the power reception coil 150 and the power transmission coil 250 face each other, and the magnetic sensor 180 and the magnet 280 face each other. That is, the power reception coil 150 and the power transmission coil 250 are close to each other and nearly overlap when viewed from the Z-axis direction. Also, the magnetic sensor 180 and the magnet 280 are close to each other and nearly overlap when viewed from the X-axis direction.

The power reception coil 150 is supported by a support member 151. The power reception circuit 160 may be built in the support member 151. The power transmission coil 250 is supported by a support member 251. The power transmission circuit 260 may be built in the support member 251. The magnetic sensor 180 is supported by a support member 181. The magnet 280 is supported by a support member 281.

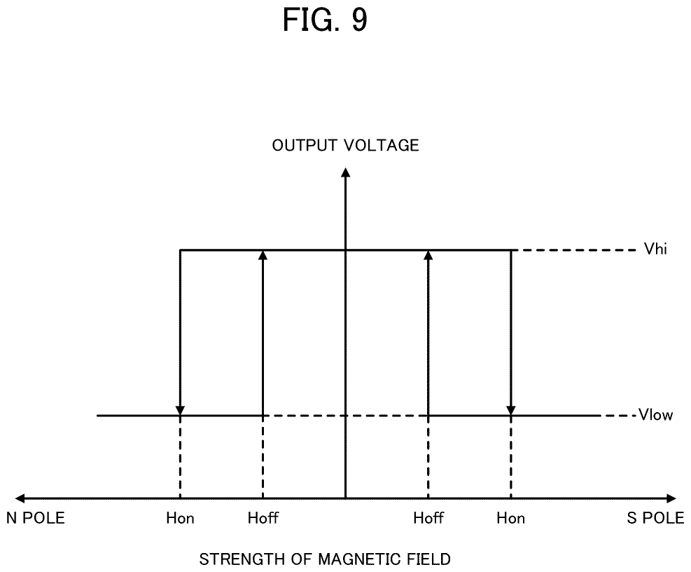

A method by which the magnetic sensor 180 detects the magnetism generated by the magnet 280 is described with reference to FIG. 8. The magnet 280 includes a magnetic pole 282 that is an N-pole and a magnetic pole 283 that is an S-pole. The magnetic poles 282 and 283 are arranged on a straight line extending in the Y-axis direction, and the Y-coordinate of the magnetic pole 282 is greater than the Y-coordinate of the magnetic pole 283. The magnetic lines of force emitted from the magnetic pole 282 flow into the magnetic pole 283. The tangential direction of the magnetic lines at a given point is the direction of the magnetic field at that point. In the stored state, the magnetic sensor 180 faces the magnet 280. The Y-coordinate of the magnetic sensor 180 and the Y-coordinate of the magnet 280 are approximately the same, and the Z-coordinate of the magnetic sensor 180 and the Z-coordinate of the magnet 280 are approximately the same. Additionally, the difference L1 between the X-coordinate of the magnetic sensor 180 and the X-coordinate of the magnet 280 is equal to or less than a predetermined reference value. For example, L1 is preferably 20 millimeters or less. In this embodiment, the magnetic sensor 180 is a rectangular parallelepiped with two surfaces orthogonal to the X-axis, two surfaces orthogonal to the Y-axis, and two surfaces orthogonal to the Z-axis. In this embodiment, the magnetic sensor 180 detects the strength of the magnetic field in the Y-axis direction. Thus, the magnetic sensor 180 detects the strength of the magnetic field corresponding to the density of the magnetic lines of force passing through the two surfaces orthogonal to the Y-axis. The magnetic sensor 180 outputs a voltage corresponding to the detected strength of the magnetic field. The electromagnetic conversion characteristics of the magnetic sensor 180 is described with reference to FIG. 9.

The output voltage of the magnetic sensor 180 is either Vhi or Vlow. Vhi is higher than Vlow. For example, Vhi is 1.6V, and Vlow is 0.2V. That is, Vhi is the second voltage, and Vlow is the first voltage. The magnetic sensor 180 outputs Vhi when no magnetism is detected and outputs Vlow when magnetism is detected. The magnetic sensor 180 outputs a voltage corresponding to the strength of the magnetic field regardless of the direction of the magnetic field. Specifically, the magnetic sensor 180 outputs Vhi when the strength of the magnetic field is less than Hoff and outputs Vlow when the strength of the magnetic field is equal to or greater than Hon. Also, when the strength of the magnetic field is equal to or greater than Hoff and less than Hon, the magnetic sensor 180 maintains the voltage that is being output. For example, when the strength of the magnetic field increases from zero, the magnetic sensor 180 switches the output voltage from Vhi to Vlow when the strength of the magnetic field reaches Hon. Also, when the strength of the magnetic field decreases from this state, the magnetic sensor 180 switches the output voltage from Vlow to Vhi at a timing when the strength of the magnetic field reaches Hoff.

When the electronic device 100 is disposed in the power supply device 200 (hereinafter referred to as an “suitable power supply device” as appropriate) that is a power supply device suitable for supplying power to the electronic device 100, the magnetism generated by the magnet 280 disposed at a predetermined part of the power supply device 200 is detected by the magnetic sensor 180 provided in the electronic device 100. In other words, in this case, the magnetic sensor 180 detects a magnetic field with a strength equal to or greater than Hon and outputs Vlow, which is the first voltage. As a result, the first voltage is applied to the operation control terminal 162 of the power reception IC 161, and the power reception IC 161 becomes operable. Consequently, the power supply request is transmitted from the power reception circuit 160 to the power transmission circuit 260, and power supply from the power supply device 200 to the electronic device 100 is achieved.

On the other hand, when the electronic device 100 is disposed in a power supply device (hereinafter referred to as “unsuitable power supply device” as appropriate) that is not suitable for supplying power to the electronic device 100, the magnetic sensor 180 provided in the electronic device 100 does not detect magnetism since the predetermined part in the unsuitable power supply device is not equipped with the magnet 280. In this case, the magnetic sensor 180 detects a magnetic field with a strength less than Hoff and outputs Vhi that is the second voltage. As a result, the second voltage is applied to the operation control terminal 162 of the power reception IC 161, and the operation of the power reception IC 161 is stopped. Consequently, the power supply request is not transmitted from the power reception circuit 160 to the power transmission circuit 260, and power supply from the power supply device 200 to the electronic device 100 is not realized.

In this way, in this embodiment, power supply from the unsuitable power supply device to the electronic device 100 is suppressed and various issues are reduced. For example, when the unsuitable power supply device does not have a foreign object detection function, heat generation caused by foreign objects is suppressed by suppressing power supply. For example, when the power transmission electrical energy of the unsuitable power supply device exceeds the receivable electrical energy of the electronic device 100, power supply exceeding the allowable amount of the electronic device 100 is suppressed by suppressing power supply. Also, for example, when the transmittable electrical energy of the unsuitable power supply device is extremely small, long-term power supply is suppressed by suppressing power supply.

In this embodiment, the power reception circuit 160 operates to allow power to be supplied from the power supply device 200 to the battery 171 in response to the sensor detecting the predetermined feature from the predetermined part of the power supply device 200. In other words, the power reception circuit 160 operates not to allow power to be supplied from the power supply device 200 to the battery 171 in response to the sensor not detecting the predetermined feature from the predetermined part of the power supply device 200. Thus, according to this embodiment, wireless power supply by an unsuitable power supply device to the electronic device 100 is suppressed. In this embodiment, the predetermined feature is a feature of generating magnetism.

In this embodiment, the power reception circuit 160 operates to allow power to be supplied from the power supply device 200 to the battery 171 in response to the magnetic sensor 180 detecting the magnetism generated by the magnet 280. Thus, according to this embodiment, wireless power supply by an unsuitable power supply device to the electronic device 100 is suppressed with a simple hardware configuration comprising the magnetic sensor 180 and the magnet 280.

In this embodiment, the power reception IC 161 operates when the first voltage is applied to the operation control terminal 162 and stops operating when the second voltage is applied to the operation control terminal 162. Also, the magnetic sensor 180 applies the first voltage to the operation control terminal 162 when magnetism is detected and applies the second voltage to the operation control terminal 162 when no magnetism is detected. In other words, in this embodiment, the power reception IC 161 operates when the magnetic sensor 180 detects magnetism and stops operating when the magnetic sensor 180 does not detect magnetism. Thus, according to this embodiment, wireless power supply by an unsuitable power supply device to the electronic device 100 is suppressed with a simple hardware configuration comprising the power reception IC 161, the magnetic sensor 180, and the magnet 280.

### Embodiment 2

In Embodiment 1, an example is described in which the predetermined feature given to the predetermined part of the suitable power supply device is a feature of generating magnetism. In this embodiment, an example is described in which the predetermined feature given to the predetermined part of the suitable power supply device is a predetermined color. Similar configurations and functions to those of Embodiment 1 are appropriately omitted or simplified.

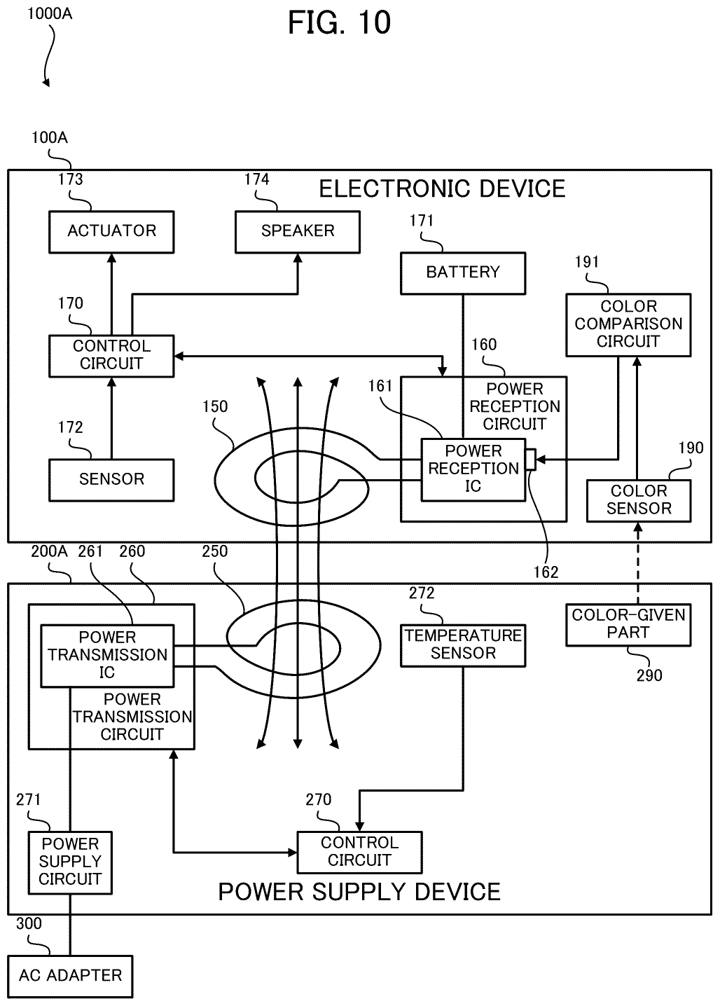

The configuration of the power transmission system 1000A according to this embodiment is described with reference to FIG. 10. The power transmission system 1000A includes an electronic device 100A and a power supply device 200A. The electronic device 100A includes the power reception coil 150, the power reception circuit 160, the control circuit 170, the battery 171, the sensor 172, then actuator 173, the speaker 174, a color sensor 190, and a color comparison circuit 191. The power supply device 200A includes the power transmission coil 250, the power transmission circuit 260, the control circuit 270, the power supply circuit 271, the temperature sensor 272, and a color-given part 290. The electronic device 100A has the same configuration as the electronic device 100, except that the electronic device 100A includes the color sensor 190 and the color comparison circuit 191 instead of the magnetic sensor 180. The power supply device 200A has the same configuration as the power supply device 200, except that the power supply device 200A includes the color-given part 290 instead of the magnet 280.

The color sensor 190 is a sensor that detects the color of the color-given part 290, which is a predetermined part of the power supply device 200A. The color sensor 190 includes a light-emitting part that emits light toward the color-given part 290 and a light-receiving part that receives light reflected from the color-given part 290. The light-emitting part includes a light-emitting diode that emits white light. The light-receiving part includes photodiodes that receive red light, blue light, and green light. The color sensor 190 outputs an analog voltage indicating the intensity of each color of light received by the light-receiving part.

The color comparison circuit 191 is a circuit that compares the color detected by the color sensor 190 with the predetermined color. For example, it is assumed that the analog voltage indicating the intensity of the detected red light is Vdr, the analog voltage indicating the intensity of the detected blue light is Vdb, and the analog voltage indicating the intensity of the detected green light is Vdg. It is also assumed that the voltage corresponding to the intensity of the red light constituting the predetermined color is Vpr, the voltage corresponding to the intensity of the blue light constituting the predetermined color is Vpb, and the voltage corresponding to the intensity of the green light constituting the predetermined color is Vpg.

In this case, for example, the color comparison circuit 191 outputs the first voltage to the operation control terminal 162 of the power reception IC 161 when the differences between Vdr and Vpr, Vdb and Vpb, and Vdg and Vpg are less than the reference values. Also, the color comparison circuit 191 outputs the second voltage to the operation control terminal 162 of the power reception IC 161 when the difference between Vdr and Vpr is equal to or greater than the reference value, the difference between Vdb and Vpb is equal to or greater than the reference value, or the difference between Vdg and Vpg is equal to or greater than the reference value. In other words, the color comparison circuit 191 operates the power reception IC 161 when the color detected by the color sensor 190 matches the predetermined color and stops the operation of the power reception IC 161 when the color detected by the color sensor 190 does not match the predetermined color.

The color-given part 290 is a predetermined part of the power supply device 200A having a predetermined color. The predetermined color indicates that the power supply device 200A is a suitable power supply device for supplying power to the electronic device 100A. The predetermined color can be any color. The color-given part 290 is a part that can be detected by the color sensor 190 in the stored state. For example, when the color sensor 190 is located at the same position as the magnetic sensor 180 in Embodiment 1, the color-given part 290 may be the protrusion 230. The electronic device 100A and the power supply device 200A are formed such that there are no obstacles between the color sensor 190 and the color-given part 290.

In this embodiment, the power reception circuit 160 operates to allow power to be supplied from the power supply device 200A to the battery 171 in response to the color sensor 190 detecting the predetermined color from the predetermined part. Thus, according to this embodiment, wireless power supply by an unsuitable power supply device to the electronic device 100A is suppressed with a simple hardware configuration comprising the color sensor 190 and the color-given part 290.

### Modified Examples

Although the embodiments are described above, the embodiments may be modified or applied in various manners. Any part of the configurations, functions, and operations described in the above embodiments may be employed. Further, besides the configurations, functions, and operations described above, additional configurations, functions, and operations may be employed. Further, the configurations, functions, and operations described in the above embodiments can be freely combined.

In Embodiments 1 and 2, examples are described in which the power supply is controlled by the power reception circuit 160, but the power supply may also be controlled by the control circuit 170. For example, the control circuit 170 may permit or prohibit power supply based on a result of detection made by the magnetic sensor 180. Specifically, the control circuit 170 may permit power supply when the magnetic sensor 180 detects magnetism and prohibit power supply when the magnetic sensor 180 does not detect magnetism. Additionally, the control circuit 170 may permit or prohibit power supply based on a result of detection made by the color sensor 190. Specifically, the control circuit 170 may permit power supply when the color sensor 190 detects the predetermined color and prohibit power supply when the color sensor 190 does not detect the predetermined color.

In Embodiment 1, an example is described in which the magnetic sensor 180 is a magnetic sensor that detects a magnetic field using a Hall element that utilizes the Hall effect. The magnetic sensor 180 may be a magnetic sensor of another type. For example, the magnetic sensor 180 may be a magnetic sensor that includes a magnetoresistive effect element that detects the magnitude of a magnetic field using the magnetoresistive effect. Additionally, for example, the magnetic sensor 180 may be a magnetic sensor that includes a reed switch that allows a lead to conduct between both ends when subjected to a magnetic field.

In Embodiment 1, an example is described in which the predetermined feature given to the predetermined part is a feature of generating magnetism, and in Embodiment 2, an example is described in which the predetermined feature given to the predetermined part is a predetermined color. The predetermined feature given to the predetermined part is not limited to these examples. For example, the predetermined feature given to the predetermined part may be a specific uneven pattern. In this case, the uneven pattern given to the predetermined part is detected by a distance sensor, a proximity sensor, an image sensor, etc. Then, when the detected uneven pattern matches the predetermined uneven pattern, the power reception IC 161 operates, and when the detected uneven pattern does not match the predetermined uneven pattern, the operation of the power reception IC 161 stops.

In Embodiment 1, an example is described in which the electronic device 100 is a robot imitating a small animal. The electronic device 100 may be other robots or non-robot devices. For example, the electronic device 100 may be a smartphone, an electronic dictionary, a game device, or the like.

In Embodiment 1, an example is described in which the first voltage is 0.2V and the second voltage is 1.6V. The first voltage and the second voltage are not limited to this example. Additionally, in Embodiment 1, an example is described in which the first voltage is lower than the second voltage. The first voltage may also be higher than the second voltage.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An electronic device, comprising:
a battery;
a power reception coil;
a power reception circuit to supply, to the battery, power wirelessly received from a power supply device through the power reception coil; and
a sensor to detect a predetermined feature given to a predetermined part of the power supply device, wherein
in response to the sensor detecting the predetermined feature from the predetermined part, the power reception circuit operates to allow power to be supplied from the power supply device to the battery.

2. The electronic device according to claim 1, further comprising:
as the sensor, a magnetic sensor to detect magnetism generated by a magnet provided in the predetermined part, wherein
in response to the magnetic sensor detecting the magnetism, the power reception circuit operates to allow power to be supplied from the power supply device to the battery.

3. The electronic device according to claim 2, wherein
the power reception circuit comprises a power reception integrated circuit (IC) including an operation control terminal, wherein
the power reception IC operates when a first voltage is applied to the operation control terminal and stops operating when a second voltage is applied to the operation control terminal, and
the magnetic sensor applies the first voltage to the operation control terminal when detecting the magnetism, and applies a second voltage to the operation control terminal when not detecting the magnetism.

4. The electronic device according to claim 1, further comprising:
as the sensor, a color sensor to detect color of the predetermined part, wherein
in response to the color sensor detecting a predetermined color as the color of the predetermined part, the power reception circuit operates to allow power to be supplied from the power supply device to the battery.

5. A power transmission system comprising a power supply device and an electronic device,
the power supply device comprising
a predetermined part to which a predetermined feature is given,
a power transmission coil, and
a power transmission circuit to supply power wirelessly to the electronic device through the power transmission coil,
the electronic device comprising
a battery,
a power reception coil,
a power reception circuit to supply, to the battery, power wirelessly received from the power supply device through the power reception coil, and
a sensor to detect the predetermined feature given to the predetermined part,
wherein
in response to the sensor detecting the predetermined feature from the predetermined part, the power reception circuit operates to allow power to be supplied from the power supply device to the battery.
